(19) United States
(12) Patent Application Publication
(10) Pub. No.: US 2020/0052343 A1
(43) Pub. Date: Feb. 13, 2020

(54) BATTERY AND METHOD FOR MANUFACTURING THE SAME, ASSEMBLED BATTERY, AND ELECTRONIC APPARATUS

(71) Applicant: MURATA MANUFACTURING CO., LTD., Kyoto (JP)

(72) Inventors: Rikako IMOTO, Kyoto (JP); Yoshiichi HORIKOSHI, Kyoto (JP); Hideki NAKAI, Kyoto (JP)

(21) Appl. No.: 16/656,075

(22) Filed: Oct. 17, 2019

Related U.S. Application Data
(63) Continuation of application No. PCT/JP2018/010369, filed on Mar. 16, 2018.

(30) Foreign Application Priority Data
Apr. 18, 2017 (JP) 2017-082187

(51) Int. Cl. H01M 10/0587; H01M 10/04; H01M 10/0525

(52) U.S. Cl. CPC H01M 10/0587; H01M 10/0422; H01M 2220/30; H01M 10/0431; H01M 10/0525

(57) ABSTRACT

A battery includes a wound electrode body with a substantially cylindrical shape, and an exterior material. The wound electrode body includes a positive electrode, a negative electrode, and a separator. The exterior material is configured to cover the wound electrode body. In at least one round from an outermost periphery of winding of the wound electrode body, one or more of a positive electrode, a negative electrode, a positive electrode current collector and a negative electrode current collector include at least one convex portion projecting in an outer peripheral direction.

### CROSS REFERENCE TO RELATED APPLICATIONS

The present application is a continuation of PCT patent application no. PCT/JP2018/010369, filed on Mar. 16, 2018, which claims priority to Japanese patent application no. JP2017-082187 filed on Apr. 18, 2017, the entire contents of which are being incorporated herein by reference.

### BACKGROUND

The present technology generally relates to a battery including a film-like exterior material and a method for manufacturing the same, an assembled battery, and an electronic apparatus.

Recently, many portable electronic apparatuses such as mobile phones and portable computers has appeared, and their size and weight have been reduced. Along with this, development of batteries, particularly secondary batteries, as portable power sources for electronic apparatuses, is actively advanced. Among them, lithium ion secondary batteries have attracted attention as being capable of achieving high energy density.

The lithium ion secondary battery is composed of a positive electrode comprising an active material that electrochemically reacts reversibly with lithium ions, a carbon material, a negative electrode containing lithium metal or lithium, and a non-aqueous electrolyte solution. Many electronic apparatuses as described above have relatively large current consumption, and a spiral electrode structure is effective as a battery structure. This is obtained by spirally winding a strip-shaped positive electrode and a strip-shaped negative electrode with a separator interposed therebetween, and can withstand a heavy load since electrode area can be taken large.

### SUMMARY

The present technology generally relates to a battery including a film-like exterior material and a method for manufacturing the same, an assembled battery, and an electronic apparatus.

As for the spiral electrode wound in this manner, a method is generally adopted in which the vicinity of the center of an outermost peripheral end portion is fixed with adhesive tape so as not to loosen the winding. Although the end portion is fixed with adhesive tape, the spiral electrode expands by charging. As a result, in a shipping state after charging, it had a disadvantage that the volumetric energy density was lowered. Furthermore, it had a disadvantage that, during a cycle, adhesion was deteriorated between the active material and the active material, between the active material and the separator, and between the active material and a metal current collector, which deteriorated charge-discharge cycle characteristics. In addition, particularly, in a battery in which a cylindrical electrode body was sealed with an exterior material having a flexibility such as a film by deformation due to charging and discharging, loosening may occur in a part of the electrode, and as a result, uniform charge/discharge reaction was not performed on the entire electrode surface, which adversely affected battery characteristics.

Therefore, an object of the present technology is to provide a battery that can suppress expansion accompanying charging of the spirally wound spiral electrode, prevent loosening of the electrode, and improve battery characteristics, and a method of manufacturing the same, an assembled battery, and an electronic apparatus.

According to an embodiment of the present disclosure, a battery is provided. The battery includes a wound electrode body with a substantially cylindrical shape and an exterior material. The wound electrode body includes a positive electrode, a negative electrode, and a separator, and the exterior material configured to cover the wound electrode body. In at least one round from an outermost periphery of winding of the wound electrode body, one or more of a positive electrode, a negative electrode, a positive electrode current collector and a negative electrode current collector include at least one convex portion projecting in an outer peripheral direction.

According to an embodiment of the present disclosure, an assembled battery is provided. The assembled battery includes a plurality of the batteries as described herein, and the batteries are connected.

According to an embodiment of the present disclosure, an electronic apparatus is provided. The electronic apparatus includes the battery as described herein.

According to an embodiment of the present disclosure, a method for manufacturing a battery is provided. The method includes forming a first film-like exterior material having a first housing part with a substantially partially cylindrical shape and a second film-like exterior material having a second housing part with a substantially partially cylindrical shape; housing a wound electrode body in the first housing part and the second housing part; when heat-molding the wound electrode body by thermal fusion, using a mold without rectangular corners or a mold in which an appropriate R-shape is formed at the corners; and forming at least one or more convex portions projecting in an outer peripheral direction on an outer peripheral surface of the wound electrode body.

According to at least one embodiment, the present technology can suppress displacement and the loosing of the electrode of the wound electrode body inside the exterior material, and can improve the battery characteristics. In addition, the effect described here is not necessarily limited, and may be any effect described in the present technology or an effect different from them, and other suitable properties relating to the present technology may be realized and as further described.

### BRIEF DESCRIPTION OF THE FIGURES

FIG. 1A is a perspective view showing an example of an appearance of a battery according to an embodiment of the present technology. FIG. 1B is an exploded perspective view showing an example of a configuration of the battery according to the embodiment of the present technology.

FIG. 2A is a top view showing an example of a shape of the battery according to an embodiment of the present technology. FIG. 2B is a cross-sectional view showing an example of a cross-sectional structure along line I-I in FIG. 2A. FIG. 2C is a cross-sectional view showing an example of a cross-sectional structure along line II-II in FIG. 2A.

FIG. 3 is a cross-sectional view showing an example of a configuration of first and second exterior materials according to an embodiment of the present technology.

FIG. 4A is a top view showing an example of a shape of a wound electrode body according to an embodiment of the present technology. FIG. 4B is an enlarged cross-sectional view of an example of a cross-sectional structure of the wound electrode body shown in FIG. 4A.

FIG. 5A is a plan view showing an example of a configuration of a positive electrode in an unwound state according to an embodiment of the present technology. FIG. 5B is a cross-sectional view showing an example of a cross-sectional structure along line I-I in FIG. 5A.

FIG. 6A is a plan view showing an example of a configuration of a negative electrode in an unwound state according to an embodiment of the present technology. FIG. 6B is a cross-sectional view showing an example of a cross-sectional structure along line I-I in FIG. 10A.

FIGS. 7A to 7D are process charts for explaining an example of a method for manufacturing the battery according to an embodiment of the present technology.

FIGS. 8A and 8B are perspective views for explaining an example of the method for manufacturing the battery according to an embodiment of the present technology.

FIGS. 9A and 9B are cross-sectional views for explaining a wound electrode body of the battery according to an embodiment of the present technology.

FIGS. 10A and 10B are cross-sectional views of a reference example for explaining an embodiment of the present technology.

FIG. 11 is a cross-sectional view for explaining another example of the wound electrode body of the battery according to an embodiment of the present technology.

FIG. 12 is a graph showing modes of inter-electrode distance of fully wound electrodes for explaining the effect of an embodiment of the present technology.

FIG. 13 is a graph showing measurement results of fusion strength between a negative electrode and a separator in a shipping state for explaining the effect of an embodiment of the present technology.

FIG. 14 is a graph showing increases in modes of inter-electrode distance of fully wound for explaining the effect of an embodiment of the present technology.

FIGS. 15A to 15D are schematic diagrams for explaining an example of a heat-molding process of the battery according to an embodiment of the present technology.

FIG. 16 is a schematic diagram for explaining an example of the heat-molding process of the battery according to an embodiment of the present technology.

FIGS. 17A and 17B are block diagrams showing an example of configurations of electronic apparatuses according to an embodiment of the present technology.

### DETAILED DESCRIPTION

As described herein, the present disclosure will be described based on examples with reference to the drawings, but the present disclosure is not to be considered limited to the examples, and various numerical values and materials in the examples are considered by way of example.

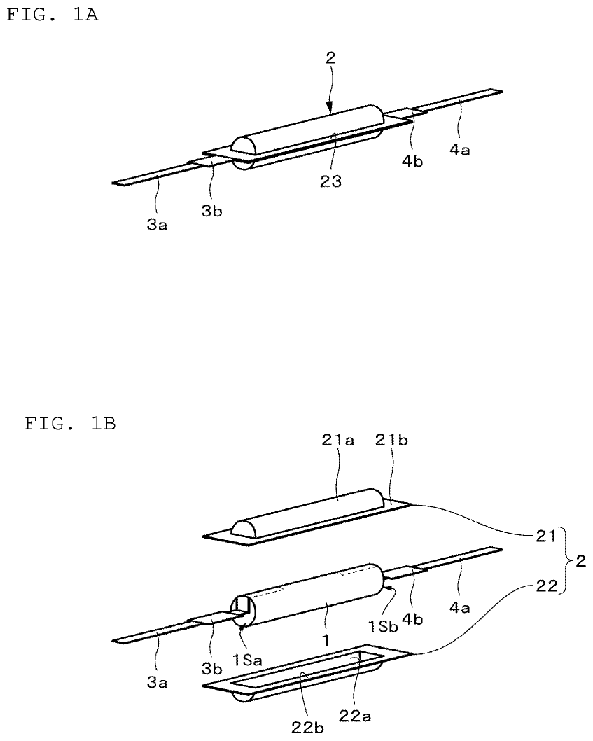

FIG. 1A shows an example of an appearance of a battery according to a first embodiment of the present technology. FIG. 1B shows an example of a configuration of the battery according to the first embodiment of the present technology. The battery is a so-called lithium ion secondary battery, and includes a wound electrode body 1 with a substantially cylindrical shape having a hollow portion in the center, an exterior material 2 having a flexibility for externally covering the wound electrode body 1, and a positive electrode lead 3a and a negative electrode lead 4a electrically connected to an outer peripheral portion of the wound electrode body 1. The exterior material 2 has a substantially cylindrical space part, and the wound electrode body 1 is housed in the space part. Moreover, joint parts 23 such as thermally fused parts are provided so as to surround four sides of the wound electrode body 1 housed in the space part.

The positive electrode lead 3a and the negative electrode lead 4a are made of, for example, a metal material such as aluminum, copper, nickel or stainless steel. Sealant materials 3b and 4b are made of a material having adhesion to the positive electrode lead 3a and the negative electrode lead 4a, respectively, for example, a polyolefin resin such as polyethylene, polypropylene, modified polyethylene, or modified polypropylene.

The exterior material 2 includes a first exterior material 21 and a second exterior material 22. The first and second exterior materials 21 and 22 are made from, for example, a rectangular film having a flexibility. It is preferable to use a laminate film as the film. The first exterior material 21 and the second exterior material 22 have substantially the same shape. Specifically, the first exterior material 21 has a substantially semi-cylindrical first space part 21a provided on one main surface, and a peripheral edge part 21b provided so as to surround four sides of the first space part 21a. On the other hand, the second exterior material 22 has a substantially semi-cylindrical second space part 22a provided on one main surface, and a peripheral edge part 22b provided so as to surround four sides of the second space part 22a. Hereinbelow, among both main surfaces of the first exterior material 21 and the second exterior material 22, a main surface on the side in which the wound electrode body 1 is housed, that is, a main surface on the side in which the first space part 21a and the second space part 22a are provided is appropriately referred to as a housing surface.

The housing surfaces of the first exterior material 21 and the second exterior material 22 are overlapped so that both are opposed to each other, and joined by thermal fusion or the like so that the peripheral edge parts 21b and 22b surround the four sides of the wound electrode body 1. Thus, a substantially cylindrical space part is formed between the first exterior material 21 and the second exterior material 22. The wound electrode body 1 with a substantially cylindrical shape is housed in the space part as described above. The space part preferably has substantially the same size as the wound electrode body 1. This is because, in a state where the wound electrode body 1 is housed in the exterior material 2, adhesion between them can be enhanced.

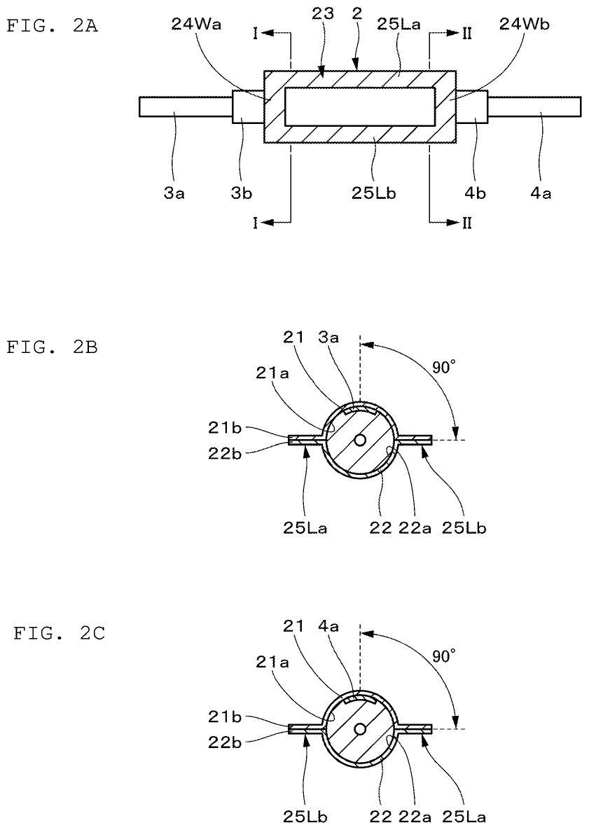

FIG. 2A shows an example of a shape of the battery according to the first embodiment of the present technology. FIG. 2B shows an example of a cross-sectional structure along line I-I shown in FIG. 2A. FIG. 2C shows an example of a cross-sectional structure along line II-II shown in FIG. 2A. The positive electrode lead 3a is provided at a position opposed to a bottom of either the first space part 21a or the second space part 22a in the outermost peripheral portion of the positive electrode included in the wound electrode body 1. On the other hand, the negative electrode lead 4a is provided at a position opposed to the bottom of either the first space part 21a or the second space part 22a in the outermost peripheral portion of the negative electrode included in the wound electrode body 1.

The joint parts 23 provided around the wound electrode body 1 include short side joint parts 24Wa and 24Wb provided on both ends of the wound electrode body 1, and peripheral surface side joint parts 25La and 25Lb provided on a peripheral surface side of the wound electrode body 1. The peripheral surface side joint parts 25La and 25Lb are provided at positions opposed to a central axis of the wound electrode body 1. FIGS. 1A and 1B show an example where the short side joint parts 24Wa and 24Wb are substantially vertically erected on end faces 1Sa and 1Sb, respectively, and the peripheral surface side joint parts 25La and 25Lb are almost vertically erected on the peripheral surface. However, shapes of the short side joint parts 24Wa and 24Wb and the peripheral surface side joint parts 25La and 25Lb are not limited thereto. For example, the short side joint parts 24Wa and 24Wb and the peripheral surface side joint parts 25La and 25Lb may be deformed by bending or curving. The positive electrode lead 3a and the negative electrode lead 4a are provided on the peripheral surface of the wound electrode body 1, for example, at positions 90 degrees clockwise or counterclockwise with respect to the position where the peripheral surface side joint parts 25La and 25Lb are provided.

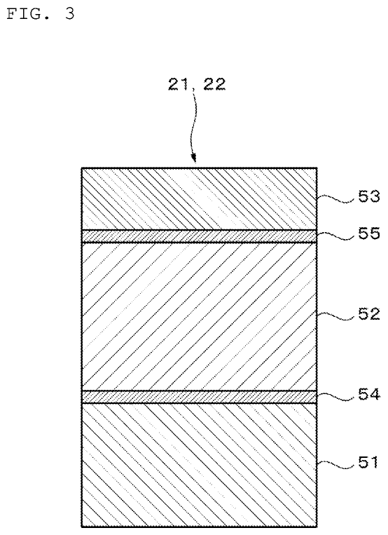

FIG. 3 is a cross-sectional view showing an example of a configuration of the first exterior material 21 and the second exterior material 22. The first exterior material 21 and the second exterior material 22 are, for example, a laminate film having moisture resistance and insulation properties, and have a laminated structure in which a thermally fusible resin layer 51 which is a first resin layer, a metal layer 52, and a surface protective layer 53 which is a second resin layer are laminated in this order. The exterior material 2 may further include an adhesive layer 54 between the thermally fusible resin layer 51 and the metal layer 52, as necessary. Moreover, an adhesive layer 55 may be further included between the metal layer 52 and the surface protective layer 53. In addition, a surface on the side of the thermally fusible resin layer 51 is a housing surface on the side for housing the wound electrode body 1.

As a material of the thermally fusible resin layer 51, it is preferable to use a resin that can be melted by heat or ultrasonic waves. As such a resin, polyolefin resins such as polypropylene (PP) and polyethylene (PE) are preferably used. For example, non-oriented polypropylene (CPP) is used. When heat is applied to the first exterior material 21 and the second exterior material 22 to seal a peripheral edge of the wound electrode body 1, the thermally fusible resin layer 51 is melted to join peripheral edges of the first exterior material 21 and the second exterior material 22.

The metal layer 52 prevents moisture, oxygen, light and the like from entering, and plays a role in protecting the wound electrode body 1 which is content. As a material of the metal layer 52, for example, metal foil made of aluminum (Al), an aluminum alloy of the like is used, in terms of lightness, extensibility, cost, ease of processing, and the like.

The surface protective layer 53 is for protecting the surfaces of the first exterior material 21 and the second exterior material 22. As a material of the surface protective layer 53, for example, nylon (Ny), polyethylene terephthalate (PET) or the like is used, in terms of beautiful appearance, toughness, flexibility, and the like.

As a material of the adhesive layers 54 and 55, for example, an adhesive of a urethane resin, an acrylic resin, a styrene resin or the like is used.

In addition, the 1st exterior material 21 and the 2nd exterior material 22 are not limited to those having the configuration described above. For example, a laminated film having a configuration different from the above-described configuration, a polymer film such as polypropylene, or a metal film may be used as the first exterior material 21 and the second exterior material 22. Moreover, as the first exterior material 21 and the second exterior material 22, one further including a colored layer and/or one in which contains a coloring material in at least one selected from the thermally fusible resin layer 51, the surface protective layer 53, the adhesive layer 54 and the adhesive layer 55 may be used, in terms of beautiful appearance. More specifically, one further including a colored layer on the surface of the surface protective layer 53, one containing a colorant in the adhesive layer 54 between the metal layer 52 and the surface protective layer 53, one containing a colorant in the surface protective layer 54 itself and the like may be used.

The thicknesses of the first exterior material 21 and the second exterior material 22 on the end face side of the wound electrode body 1 and the thicknesses of the first exterior material 21 and the second exterior material 22 on the peripheral surface side of the wound electrode body 1 may be different. More specifically, for example, the thicknesses of the first exterior material 21 and the second exterior material 22 on the end face side of the wound electrode body 1 may be thinner than the thicknesses of the first exterior material 21 and the second exterior material 22 on the peripheral surface side of the wound electrode body 1.

When the first exterior material 21 and the second exterior material 22 have a laminated structure including a metal layer, the thickness of the metal layer on the end face side of the wound electrode body 1 and the thickness of the metal layer on the peripheral surface side of the wound electrode body 1 may be different. More specifically, for example, the thickness of the metal layer on the end face side of the wound electrode body 1 may be thinner than the thickness of the metal layer on the peripheral surface side of the wound electrode body 1.

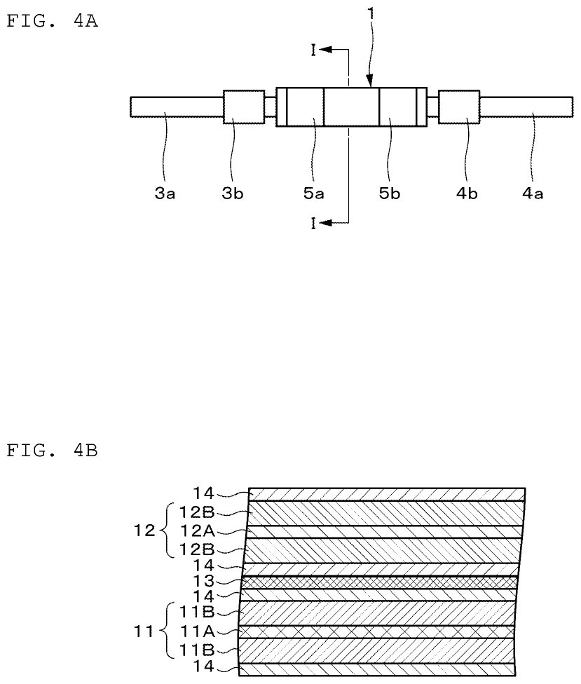

FIG. 4A shows an example of a shape of the wound electrode body 1. On the peripheral surface of the wound electrode body 1, winding stopping parts 5a and 5b for winding and stopping the wound electrode body 1 are provided. It is preferable that the winding stopping parts 5a and 5b cover the peripheral surface of the wound electrode body 1 once or more, and also cover at least both end portions of the peripheral surface of the wound electrode body 1. This is because deformation of the wound electrode body 1 associated with charge and discharge or the like can be suppressed. For example, as the winding stopping parts 5a and 5b, a rectangular tape or the like is used, but it is not limited thereto. FIG. 4A shows an example in which both ends of the peripheral surface of the wound electrode body 1 are wound and stopped by the two winding stopping parts 5a and 5b, but the number of winding stopping parts and the arrangement position of the winding stopping parts are not limited thereto. For example, the number of winding stopping parts may be one or three or more. In addition, the arrangement position of the winding stopping parts may be a central portion of the peripheral surface of the wound electrode body 1. Further, the number of turns of the winding stopping parts 5a and 5b wound around the peripheral surface of the wound electrode body 1 is not limited to one or more, and may be less than one.

FIG. 4B represents an enlarged view of an example of a cross-sectional structure of the wound electrode body 1 shown in FIG. 4A. The wound electrode body 1 includes a positive electrode 11, a negative electrode 12, a separator 13, and an electrolyte layer 14, and the positive electrode 11, the negative electrode 12 and the separator 13 have, for example, an elongated rectangular shape. The wound electrode body 1 has a winding structure in which the positive electrode 11 and the negative electrode 12 are wound in the longitudinal direction with the separator 13 interposed therebetween. The wound electrode body 1 is wound, for example, so that both the innermost and outermost electrodes become the negative electrode 12. An electrolyte layer 14 is provided between the positive electrode 11 and the separator 13 and between the negative electrode 12 and the separator 13.

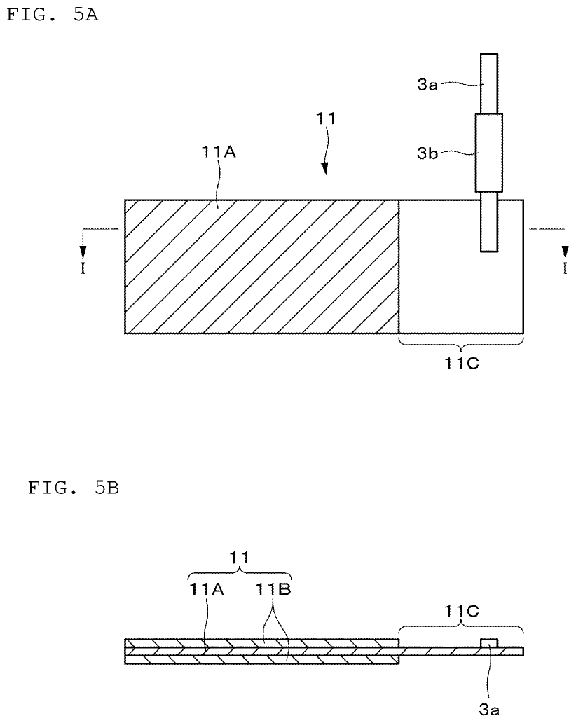

FIG. 5A shows an example of a configuration of the positive electrode 11 in an unwound state. FIG. 5B shows an example of a cross-sectional structure along line I-I shown in FIG. 5A. The positive electrode 11 includes, for example, a positive electrode current collector 11A, and a positive electrode active material layer 11B provided on both sides of the positive electrode current collector 11A. Although not shown, the positive electrode active material layer 11B may be provided only on one side of the positive electrode current collector 11A.

One end of the positive electrode 11 in the longitudinal direction is the inner peripheral side of the wound electrode body 1, and the other end of the positive electrode 11 in the longitudinal direction is the outer peripheral side of the wound electrode body 1. A positive electrode current collector exposed portion 11C is provided at the other end of the positive electrode 11 on the outer peripheral side, and a positive electrode current collector exposed portion 11C is not provided at one end of the positive electrode 11 on the inner peripheral side and the positive electrode active material layer 11B is provided to a tip. The positive electrode current collector exposed portion 11C is provided, for example, on both surfaces of the other end of the positive electrode 11. The positive electrode lead 3a is provided on an exposed portion of the surface on the outer peripheral side of the positive electrode current collector exposed portion 11C provided on the both surfaces thereof. The sealant material 3b is preferably provided apart from a long side of the positive electrode 11 so as not to overlap with the positive electrode current collector exposed portion 11C.

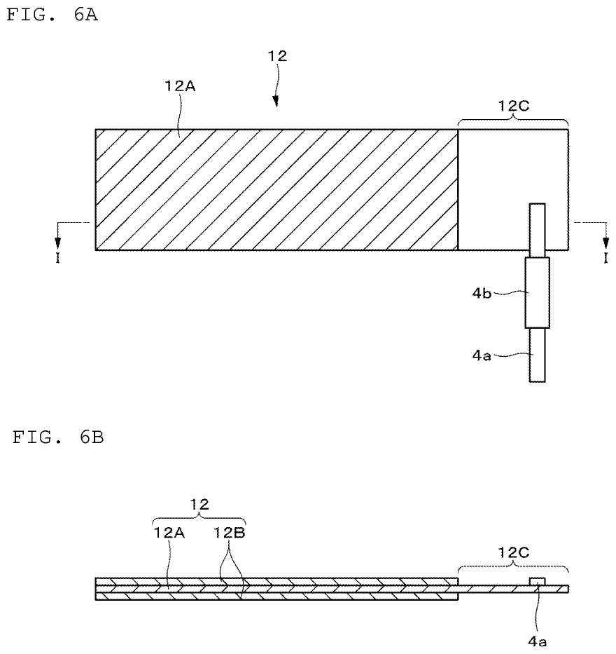

FIG. 6A shows an example of a configuration of the negative electrode 12 in an unwound state. FIG. 6B shows an example of a cross-sectional structure along line I-I shown in FIG. 6A. The negative electrode 12 includes, for example, a negative electrode current collector 12A, and a negative electrode active material layer 12B provided on both sides of the negative electrode current collector 12A. Although not shown, the negative electrode active material layer 12B may be provided only on one side of the negative electrode current collector 12A.

One end of the negative electrode 12 in the longitudinal direction is the inner peripheral side of the wound electrode body 1, and the other end of the negative electrode 12 in the longitudinal direction is the outer peripheral side of the wound electrode body 1. A positive electrode current collector exposed portion 12C is provided at the other end of the negative electrode 12 on the outer peripheral side, and a positive electrode current collector exposed portion 12C is not provided at one end of the negative electrode 12 on the inner peripheral side and the negative electrode active material layer 12B is provided to a tip. The negative electrode current collector exposed portion 12C is provided, for example, on both surfaces of the other end of the negative electrode 12. The negative electrode lead 4a is provided on an exposed portion of the surface on the outer peripheral side of the negative electrode current collector exposed portion 12C provided on the both surfaces thereof. It is preferable to further provide a protective layer on the negative electrode current collector exposed portion 12C as well as the positive electrode current collector exposed portion 11C. The sealant material 4b is preferably provided apart from a long side of the negative electrode 12 so as not to overlap with the negative electrode current collector exposed portion 12C.

As described above, by providing the positive electrode lead 3a and the negative electrode lead 4a on the outermost periphery of the positive electrode 11 and the negative electrode 12, respectively, the size of the wound electrode body 1 can be reduced. Further, by providing the positive electrode current collector exposed portion 11C and the negative electrode current collector exposed portion 12C only at the end portions on the outermost periphery of the positive electrode 11 and the negative electrode 12, respectively, the size of the wound electrode body 1 can be further reduced.

The positive electrode current collector 11A is made of, for example, metal foil such as aluminum foil, nickel foil, or stainless steel foil. The positive electrode active material layer 11B is composed by containing, for example, one or two or more of positive electrode materials capable of occluding and releasing lithium as a positive electrode active material, and as necessary, containing a conductive agent such as graphite and a binder such as polyvinylidene fluoride.

As a positive electrode material capable of occluding and releasing lithium, for example, a lithium-containing compound such as lithium oxide, lithium phosphorus oxide, lithium sulfide or an interlayer compound containing lithium is suitable, and two or more of them may be mixed and used. In order to increase the energy density, a lithium-containing compound containing lithium, a transition metal element and oxygen (O) is preferable. Examples of such a lithium-containing compound include lithium composite oxides having a layered rock salt structure shown in formula (A), lithium composite phosphates having an olivine structure shown in formula (B), and the like. It is more preferable that the lithium-containing compound contains at least one from the group consisting of cobalt (Co), nickel (Ni), manganese (Mn) and iron (Fe) as a transition metal element. Examples of such a lithium-containing compound include lithium composite oxides having a layered rock salt structure shown in formula (C), formula (D) or formula (E), lithium composite oxides having a spinel structure shown in formula (F), lithium composite phosphates having an olivine structure shown in formula (G), and the like, and are specifically, LiNi_{0.50}Co_{0.20}Mn_{0.30}O₂, LiₐCoO₂ (a≈1), Li_{b}NiO₂ (b≈1), Li_{c1}Ni_{c2}Co_{1-c2}O₂ (c1≈1, 0<c2<1), Li_{d}Mn₂O₄ (d≈1), LiₑFePO₄ (e≈1), and the like.

LiₚNi_{(1-q-r)}Mn_{q}M1ᵣO_{(2-y)}X_{z} . . . (A)

where M1 represents at least one element selected from Groups 2 to 15 excluding nickel (Ni) and manganese (Mn), X represents at least one of Group 16 elements excluding oxygen (O) and Group 17 elements, and p, q, y and z are values within the ranges of 0≤p≤1.5, 0≤q≤1.0, 0≤r≤1.0, −0.10≤y≤0.20, and 0≤z≤0.2.

LiₐM2_{b}PO₄ . . . (B)

where M2 represents at least one element selected from Groups 2 to 15, and a and b are values within the ranges of 0≤a≤2.0, and 0.5≤b≤2.0.

Li_{f}Mn_{(1-g-h)}Ni_{g}M3ₕO₍₂₋ⱼ₎Fₖ . . . (C)

where M3 represents at least one from the group consisting of cobalt (Co), magnesium (Mg), aluminum (Al), boron (B), titanium (Ti), vanadium (V), chromium (Cr), iron (Fe), copper (Cu), zinc (Zn), zirconium (Zr), molybdenum (Mo), tin (Sn), calcium (Ca), strontium (Sr), and tungsten (W), and f, g, h, j and k are values within the ranges of 0.8≤f≤1.2, 0<g <0.5, 0≤h≤0.5, g+h<1, −0.1≤j≤0.2, and 0≤k≤0.1. It is to be noted that the composition of lithium varies depending on the state of charge/discharge, and the value of f represents a value in a fully discharged state.

LiₘNi₍₁₋ₙ₎M4ₙO₍₂₋ₚ₎F_{q} . . . (D)

where M4 represents at least one from the group consisting of cobalt (Co), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W), and m, n, p and q are values within the ranges of 0.8≤m≤1.2, 0.005≤n ≤0.5, −0.1≤p≤0.2, and 0≤q≤0.1. It is to be noted that the composition of lithium varies depending on the state of charge/discharge, and the value of m represents a value in a fully discharged state.

LiᵣCo₍₁₋ₛ₎M5ₛO₍₂₋ₜ₎Fᵤ . . . (E)

where M5 represents at least one from the group consisting of nickel (Ni), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W), and r, s, t and u are values within the ranges of 0.8≤r≤1.2, 0≤s<0.5, −0.1≤t≤0.2, and 0≤u≤0.1. It is to be noted that the composition of lithium varies depending on the state of charge/discharge, and the value of r represents a value in a fully discharged state.

LiᵥMn_{2-w}M6_{w}OₓF_{y} . . . (F)

where M6 represents at least one from the group consisting of cobalt (Co), nickel (Ni), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W), and v, w, x and y are values within the ranges of 0.9≤v≤1.1, 0≤w≤0.6, 3.7≤x≤4.1, and 0≤y≤0.1. It is to be noted that the composition of lithium varies depending on the state of charge/discharge, and the value of v represents a value in a fully discharged state.

Li_{z}M7PO₄ . . . (G)

where M7 represents at least one from the group consisting of cobalt (Co), manganese (Mn), iron (Fe), nickel (Ni), magnesium (Mg), aluminum (Al), boron (B), titanium (Ti), vanadium (V), niobium (Nb), copper (Cu), zinc (Zn), molybdenum (Mo), calcium (Ca), strontium (Sr), tungsten (W), and zirconium (Zr), and z is a value within the range of 0.9≤z≤1.1. It is to be noted that the composition of lithium varies depending on the state of charge/discharge, and the value of z represents a value in a fully discharged state.

In addition to the foregoing, other examples of the positive electrode material capable of occluding and releasing lithium also include inorganic compounds containing no lithium, such as MnO₂, V₂O₅, V₆O₁₃, NiS, and MoS.

The positive electrode material capable of occluding and releasing lithium may be any other than those described above. In addition, two or more of the positive electrode materials exemplified above may be mixed in arbitrary combination.

The negative electrode current collector 12A is made of, for example, metal foil such as copper foil, nickel foil, or stainless steel foil. The negative electrode active material layer 12B is composed by containing any one or two or more negative electrode materials capable of occluding and releasing lithium as a negative electrode active material, and as necessary, composed by containing the same binder as in the positive electrode active material layer 11B.

In this battery, the electrochemical equivalent of the negative electrode material capable of occluding and releasing lithium is larger than the electrochemical equivalent of the positive electrode 11, and lithium metal is not deposited on the negative electrode 12 during charging.

Examples of the negative electrode material capable of occluding and releasing lithium include carbon materials such as non-graphitizable carbon, graphitizable carbon, graphite, pyrolytic carbons, cokes, glassy carbons, organic polymer compound fired bodies, carbon fiber or activated carbon. As the graphite, it is preferable to use natural graphite which has been subjected to a spheroidizing treatment or the like, and substantially spherical artificial graphite. As the artificial graphite, artificial graphite obtained by graphitizing mesocarbon microbeads (MCMB), or artificial graphite obtained by graphitizing and pulverizing a coke raw material is preferable. The cokes includes pitch coke, needle coke or petroleum coke. An organic polymer compound fired body refers to a material obtained by firing a polymer material such as a phenol resin or a furan resin at an appropriate temperature and carbonizing the resultant material, and some of the fired bodies are classified into non-graphitizable carbon or graphitizable carbon. Further, the polymer material includes polyacetylene or polypyrrole. These carbon materials are preferred because very little change occurs in the crystal structure generated during charging/discharging, a high charge/discharge capacity can be obtained, and good cycle characteristics can be obtained. In particular, graphite is preferred because it has a large electrochemical equivalent and high energy density can be obtained. In addition, non-graphitizable carbon is preferred because excellent cycle characteristics are obtained.

Furthermore, materials that are low in charge/discharge potential, specifically, materials that are close in charging/discharging potential to lithium metal, are preferred because high energy density of the battery can be easily realized.

Examples of the negative electrode material capable of occluding and releasing lithium also include materials capable of occluding and releasing lithium containing at least one of metal elements and metalloid elements as a constituent element. Here, the negative electrode 12 containing such a negative electrode material is referred to as an alloy-based negative electrode. This is because use of such a material can obtain a high energy density. In particular, use together with a carbon material is more preferred because a high energy density can be obtained, and because excellent cycle characteristics can be obtained. The negative electrode material may be a simple substance, alloy, or compound of the metal element or the metalloid element, or may be a material that at least partially has a phase of one or two or more thereof. In the present technology, examples of the alloy includes, in addition to alloys composed of two or more metal elements, alloys containing one or more metal elements and one or more metalloid elements. In addition, the alloy may also contain a nonmetallic element. The structure includes a solid solution, a eutectic (eutectic mixture), an intermetallic compound, or one in which two or more kinds thereof coexist.

Examples of the metal element or the metalloid element constituting the negative electrode material include magnesium (Mg), boron (B), aluminum (Al), gallium (Ga), indium (In), silicon (Si), germanium (Ge), tin (Sn), lead (Pb), bismuth (Bi), cadmium (Cd), silver (Ag), zinc (Zn), hafnium (Hf), zirconium (Zr), yttrium (Y), palladium (Pd), and platinum (Pt). These may be crystalline or amorphous.

Above them, as the negative electrode material, a material containing a metal element or a metalloid element of Group 4B in the short period periodic table as a constituent element is preferred, and a material containing at least one of silicon (Si) and tin (Sn) as a constituent element is particularly preferred. This is because silicon (Si) and tin (Sn) have a large capability capable of occluding and releasing lithium (Li), and can obtain a high energy density.

Examples of an alloy of tin (Sn) include an alloy containing, as a second constituent element other than tin (Sn), at least one from the group consisting of silicon (Si), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), and chromium (Cr). Examples of an alloy of silicon (Si) include an alloy containing, as a second constituent element other than silicon (Si), at least one from the group consisting of tin (Sn), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), and chromium (Cr).

Examples of a compound of tin (Sn) or a compound of silicon (Si) include compounds containing oxygen (O) or carbon (C), and may contain, in addition to tin (Sn) or silicon (Si), the second constituent element described above.

Examples of the negative electrode material capable of occluding and releasing lithium further include other metal compounds and polymer materials. Examples of the other metal compounds include oxides such as MnO₂, V₂O₅ and V₆O₁₃, sulfides such as NiS and MoS, and lithium nitrides such as LiN₃. Examples of the polymer materials include polyacetylene, polyaniline, polypyrrole, and the like.

The separator 13 separates the positive electrode 11 and the negative electrode 12, and allows lithium ions to pass through while preventing short circuit of current due to contact between both electrodes. The separator 13 is composed of, for example, a porous membrane made of synthetic resin composed of polytetrafluoroethylene, polypropylene, polyethylene or the like, or a porous membrane made of ceramic, and may have a structure in which two or more of these porous membranes are laminated. Among them, a porous membrane made of polyolefin is preferable because it has an excellent short circuit-prevention effect and can improve safety of the battery by a shutdown effect. In particular, polyethylene is preferred as a material constituting the separator 13 because polyethylene can obtain the shutdown effect within the range of 100° C. or more and 160° C. or less, and also has excellent electrochemical stability. In addition, polypropylene is also preferable, and besides, a chemically stable resin can be used by being copolymerized or blended with polyethylene or polypropylene.

The electrolyte layer 14 includes a non-aqueous electrolyte solution, and a polymer compound serving as a holding body for holding the non-aqueous electrolyte solution, and the polymer compound is swollen by the non-aqueous electrolyte solution. The content ratio of the polymer compound can be adjusted appropriately. In particular, in the case of using a gel-like electrolyte, high ionic conductivity can be obtained, and liquid leakage from the battery can be prevented, which are preferable.

The non-aqueous electrolyte solution contains, for example, a solvent and an electrolyte salt. Examples of the solvent include 4-fluoro-1,3-dioxolan-2-one, ethylene carbonate, propylene carbonate, butylene carbonate, vinylene carbonate, dimethyl carbonate, diethyl carbonate, ethyl methyl carbonate, γ-butyrolactone, γ-valerolactone, 1,2-dimethoxyethane, tetrahydrofuran, 2-methyltetrahydrofuran, 1,3-dioxolane, 4-methyl-1,3-dioxolane, methyl acetate, methyl propionate, ethyl propionate, propyl propionate, acetonitrile, glutaronitrile, adiponitrile, methoxyacetonitrile, 3-methoxypropylonitrile, N,N-dimethylformamide, N-methylpyrrolidinone, N-methyloxazolidinone, nitromethane, nitroethane, sulfolane, dimethyl sulfoxide, trimethyl phosphate, triethyl phosphate, ethylene sulfite, and ambient temperature molten salts such as bis(trifluoromethylsulfonyl)imide trimethylhexyl ammonium.

Among them, use of at least one of the group consisting of 4-fluoro-1,3-dioxolan-2-one, ethylene carbonate, propylene carbonate, vinylene carbonate, dimethyl carbonate, ethyl methyl carbonate, and ethylene sulfite in mixture is preferred because excellent charge/discharge capacity characteristics and charge/discharge cycle characteristics can be obtained. The electrolyte layer 14 may contain known additives, in order to improve battery characteristics.

The electrolyte salt may contain one or two or more materials in mixture. Examples of the electrolyte salt include lithium hexafluorophosphate (LiPF₆), lithium bis(pentafluoroethanesulfonyl)imide (LiN(C₂F₅SO₂)₂), lithium perchlorate (LiClO₄), lithium hexafluoroarsenate (LiAsF₆), lithium tetrafluoroborate (LiBF₄), lithium trifluoromethanesulfonate (LiSO₃CF₃), lithium bis(trifluoromethanesulfonyl)imide (Li(CF₃SO₂)₂N), lithium bis(fluorosulfonyl)imide (LiN(SO₂F)₂), lithium tris(trifluoromethanesulfonyl)methyl (LiC(SO₂CF₃)₃), lithium chloride (LiCl), and lithium bromide (LiBr).

Examples of the polymer compound include polyacrylonitrile, polyvinylidene fluoride, a copolymer of vinylidene fluoride and hexafluoropropylene, polytetrafluoroethylene, polyhexafluoropropylene, polyethylene oxide, polypropylene oxide, polyphosphazene, polysiloxane, polyvinyl acetate, polyvinyl alcohol, polymethyl methacrylate, polyacrylic acid, polymethacrylic acid, styrene-butadiene rubber, nitrile-butadiene rubber, polystyrene, and polycarbonate. Particularly, in terms of electrochemical stability, polyacrylonitrile, polyvinylidene fluoride, polyhexafluoropropylene or polyethylene oxide is preferred.

Hereinafter, with reference to FIGS. 5A, 5B, 6A, 6B, 7A to 7D, 8A, and 8B, an example of a method for manufacturing a battery according to the embodiment of the present technology will be described.

First, for example, a positive electrode mixture is prepared by mixing a positive electrode active material, a conductive agent, and a binder, and this positive electrode mixture is dispersed in a solvent such as N-methyl-2-pyrrolidone to prepare a paste-like positive electrode mixture slurry. Next, the positive electrode mixture slurry is applied to the positive electrode current collector 11A, subjected to solvent drying, and subjected to compression molding by a roll press machine or the like to form the positive electrode active material layer 11B, thereby forming the positive electrode 11.

Further, for example, a negative electrode mixture is prepared by mixing a negative electrode active material and a binder, and this negative electrode mixture is dispersed in a solvent such as N-methyl-2-pyrrolidone to prepare a paste-like negative electrode mixture slurry. Next, the negative electrode mixture slurry is applied to the negative electrode current collector 12A, subjected to solvent drying, and subjected to compression molding by a roll press machine or the like to form the negative electrode active material layer 12B, thereby preparing the negative electrode 12.

Next, a precursor solution containing a solvent, an electrolyte salt, a polymer compound, and a mixed solvent is applied on each of the active material layers of the positive electrode 11 and the negative electrode 12, and the mixed solvent is volatilized to form the electrolyte layer 14. Next, as shown in FIGS. 5A and 5B, the positive electrode lead 3a is electrically connected to the positive electrode current collector exposed portion 11C of the positive electrode 11. Next, as shown in FIGS. 6A and 6B, the negative electrode lead 4a is electrically connected to the negative electrode current collector exposed portion 12C of the negative electrode 12. Examples of the connection method include ultrasonic welding, resistance welding, soldering and the like, and in consideration of damage to the connection portion due to heat, it is preferable to use a method which is less thermally affected, such as ultrasonic melting and resistance welding.

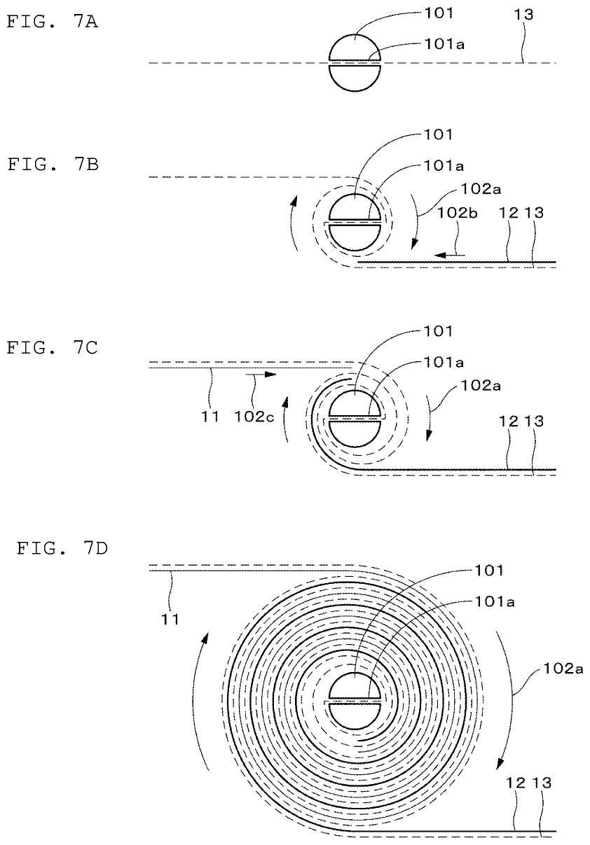

Next, as shown in FIG. 7A, the substantially central position in the longitudinal direction of the separator 13 is inserted into a gap 101a of a core 101 or suctioned to a hollow cylindrical core 101, and then as shown in FIG. 7B, the core 101 is rotated in the direction indicated by arrow 102a to wind the separator 13 around the peripheral surface of the core 101. Next, the negative electrode 12 is supplied between the separators 13 turned back from the substantially central position. Thus, the negative electrode 12 is caught between the separators 13 as the core 101 rotates.

Next, as shown in FIG. 7C, the positive electrode 11 is supplied between the separators 13 in the direction indicated by arrow 102c so that the positive electrode 11 and the negative electrode 12 overlap each other with the separator 13 interposed therebetween. Thus, the positive electrode 11 is caught between the separators 13 as the core 101 rotates. Next, as shown in FIG. 7D, the rotation of the core 101 is continued, and the positive electrode 11, the negative electrode 12 and the separator 13 are wound a predetermined number of times. A protective tape is adhered to the outermost peripheral portion, whereby the wound electrode body 1 is obtained.

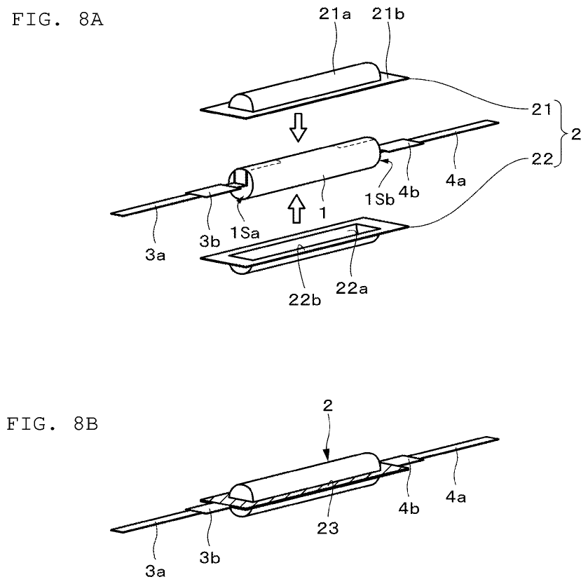

Next, as shown in FIG. 8A, housing surfaces of a first exterior material 21 and a second exterior material 22 are overlapped each other such that the wound electrode body 1 is housed in a first space part 21a of the first exterior material 21 and a second space part 22a of the second exterior material 22. Next, as shown in FIG. 8B, a peripheral edge part 21b of the first exterior material 21 and a peripheral edge part 22b of the second exterior material 22 are joined by thermal fusion or the like in a vacuum atmosphere. As a result, joint parts 23 are formed around the wound electrode body 1, and the wound electrode body 1 is sealed by the first exterior material 21 and the second exterior material 22. Subsequently, the exterior material 2 is heated while applying a load, and the separator 13 is brought into close contact with the positive electrode 11 and the negative electrode 12 with the electrolyte layer 14 interposed therebetween. Thus, a part of the electrolyte is impregnated in the separator. In the way described above, the target battery can be obtained.

The battery according to the first embodiment may be prepared as follows. First, the positive electrode 11 and the negative electrode 12 are prepared, and the positive electrode lead 3a and the negative electrode lead 4a are attached to the positive electrode 11 and the negative electrode 12, respectively, as described above. Next, the positive electrode 11 and the negative electrode 12 are wound with the separator 13 interposed therebetween, and a protective tape is adhered to the outermost peripheral portion to form the wound electrode body 1. Next, the wound electrode body 1 is sandwiched by the exterior materials 2 and the outer peripheral edge part excluding one side is thermally fused to form a bag shape, and is stored inside the exterior material 2. Next, a composition for electrolyte containing a solvent, an electrolyte salt, a monomer which is a raw material of a polymer compound, a polymerization initiator, and as necessary, other materials such as a polymerization inhibitor, is prepared, and injected into the inside of the exterior material 2.

Next, a cavity of the exterior material 2 is thermally fused and sealed in a vacuum atmosphere. Next, heat is applied to polymerize the monomers to form a polymer compound, whereby the electrolyte layer 14 is formed. In the way described above, the target battery can be obtained.

The battery according to the first embodiment may be prepared as follows. In this preparation method, the wound electrode body 1 is prepared in the same manner as in the second manufacturing method described above, except that a separator 13 coated with a polymer compound on both sides is used, and stored inside bag-shaped exterior material 2. The polymer compound to be applied to this separator 13 is, for example, a polymer (homopolymer, copolymer or multi-component copolymer) composed of vinylidene fluoride as a component or the like. Specifically, it is polyvinylidene fluoride, a binary copolymer composed of vinylidene fluoride and hexafluoropropylene as components, a ternary copolymer weight composed of vinylidene fluoride, hexafluoropropylene and chlorotrifluoroethylene as components, or the like In addition, one or two or more types of other polymer compounds may be used together with a polymer composed of vinylidene fluoride.

Next, an electrolyte solution is prepared and injected into the exterior material 2, and then the cavity of the exterior material 2 is hermetically sealed using a thermal fusion method or the like. Subsequently, the exterior material 2 is heated while applying a load, and the separator 13 is brought into close contact with the positive electrode 11 and the negative electrode 12 with the polymer compound interposed therebetween. Accordingly, since the positive and negative electrodes are impregnated and also the polymer compound is impregnated with the electrolyte solution, the polymer compound is gelatinized to form the electrolyte layer 14.

The battery according to the first embodiment may be prepared as follows. First, the positive electrode 11 and the negative electrode 12 are prepared, and the positive electrode lead 3a and the negative electrode lead 4a are attached to the positive electrode 11 and the negative electrode 12, respectively, as described above. Next, the positive electrode 11 and the negative electrode 12 are wound with the separator 13 interposed therebetween, and a protective tape is adhered to the outermost peripheral portion to form the wound electrode body 1. Next, the wound body is sandwiched by the exterior materials 2 and the outer peripheral edge part excluding one side is thermally fused to form a bag shape, and is stored inside the exterior material 2. Next, a composition for electrolyte containing a solvent and an electrolyte salt is prepared, and injected into the inside of the exterior material 2. Next, a cavity of the exterior material 2 is thermally fused and sealed in a vacuum atmosphere. In the way described above, the target battery can be obtained.

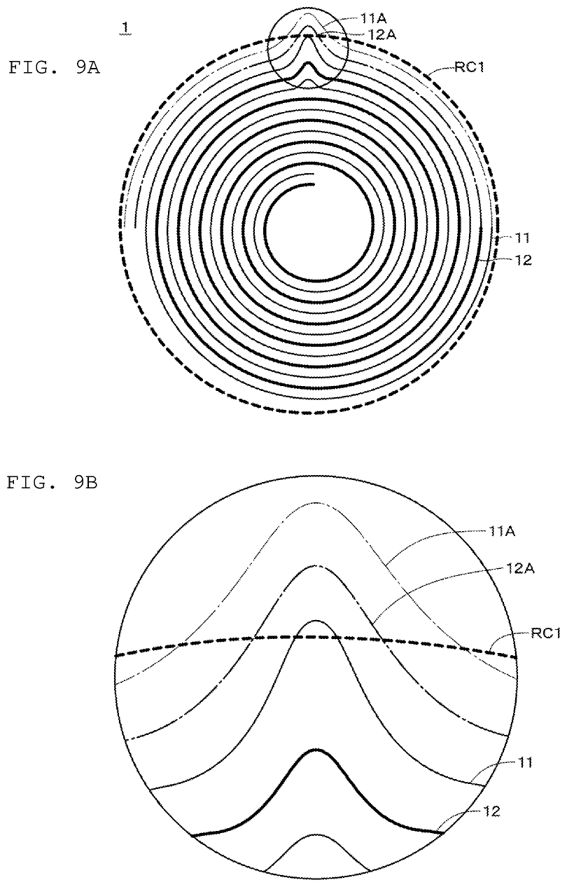

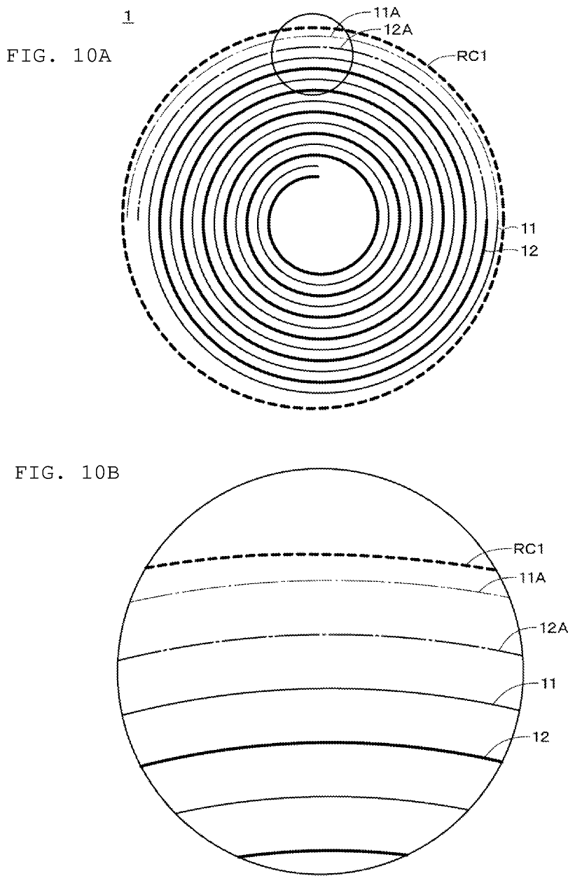

In the battery according to the first embodiment, a schematic view of an X-ray CT image cross section taken along line I-I in FIG. 4A is shown in FIG. 9A, and an enlarged image thereof is shown in FIG. 9B. In a battery having no convex portion projecting in an outer peripheral direction on the outermost peripheral current collector portion or the like of the wound electrode body, a schematic view of an X-ray CT image cross section taken along the line I-I in FIG. 4A is shown in FIG. 10A, and an enlarged image thereof is shown in FIG. 10B. The exterior material 2 and the separator 13 are omitted in FIGS. 9 and 10 for the sake of simplicity. Further, in order to facilitate understanding of the winding structure of the positive electrode 11 and the negative electrode 12, illustration of the electrolyte layer 14 is omitted.

For example, imaging of the battery cross section is performed by the following X-ray CT analysis method. The imaging conditions are as follows: image horizontal size: 2048 [pixel], image vertical size: 1124 [pixel], X-ray tube voltage: 140 [kV], X-ray tube current: 40 [μA], detector size: 40 cm wide and 30 cm long, distance from X-ray source to screen: 900 [mm], distance from X-ray source to battery: 28 [mm], and the number of views: 1,440 [View]. The reconstruction condition is 2048×2048×96 voxels with a voxel pitch of 3 μm. This cross-sectional image can also be acquired by FIB-SEM or electron beam tomography or the like.

As shown in FIG. 9A, in the first embodiment, in at least one round from the outermost periphery of winding of the wound electrode body 1, at least one of the positive electrode 11, the negative electrode 12, the positive electrode current collector 11A or the negative electrode current collector 12A forms a convex portion. The convex portion has, for example, a substantially triangular cross section whose width is narrowed toward the tip, and is in the form of a ridge continuously formed in the longitudinal direction of the wound electrode body 1. Curve RC1 is obtained by circular approximation of the central portion in the thickness direction of the metal layer 52 of the exterior material 2. For example, coordinates of three points on the exterior material 2 can be determined by substituting them into circle equation (x−a)²+(y−b)²=r².

In at least one round from the outermost periphery of winding of the wound electrode body 1, the curve RC1 obtained by circular approximation of the exterior material crosses at least one of the positive electrode 11, the negative electrode 12, the positive electrode current collector 11A or the negative electrode current collector 12A. Thus, the outermost peripheral positive electrode current collector, the outermost peripheral negative electrode current collector, and the outermost peripheral positive electrode active material layer which cross the curve RC1 have a high anchor effect, and movement of the wound electrode body 1 inside the laminate exterior material 2 can be suppressed. That is, the convex portion of the wound electrode body 1 enters a concave portion of the inner surface of the exterior material 2, whereby displacement such as rotation of the wound electrode body 1 inside the exterior material 2 is suppressed. As a result, expansion of the wound electrode body 1 and loosening of the wound electrode body 1 can be suppressed. Thus, swelling by an initial charge performed before shipment can be suppressed. Furthermore, in a subsequent cycle, it is possible to suppress swelling due to the cycle or improve cycle characteristics.

Further, as a projection amount of the convex portion of the wound electrode body 1, the height of the convex portion of the positive electrode 11, the negative electrode 12, the positive electrode current collector 11A or the negative electrode current collector 12A is 10 μm or more and 1 mm or less, using a curve obtained by circular approximation of the positive electrode 11, the negative electrode 12, the positive electrode current collector 11A or the negative electrode current collector 12A located on the outermost peripheral surface as a reference line.

In the case of a wound electrode body in which no convex portion is formed in an outer peripheral direction as shown in FIG. 10, the curve RC1 obtained by circular approximation of the exterior material 2 does not cross an outermost peripheral positive electrode current collector 11A, an outermost peripheral negative electrode current collector 12A, and an outermost peripheral positive electrode active material layer 11B. Thus, the outermost peripheral positive electrode current collector 11A, the outermost peripheral negative electrode current collector 12A, and the outermost peripheral positive electrode active material layer 11B which do not cross the curve RC1 have a low anchor effect, and the displacement of the wound electrode body 1 inside the laminate exterior material cannot be suppressed.

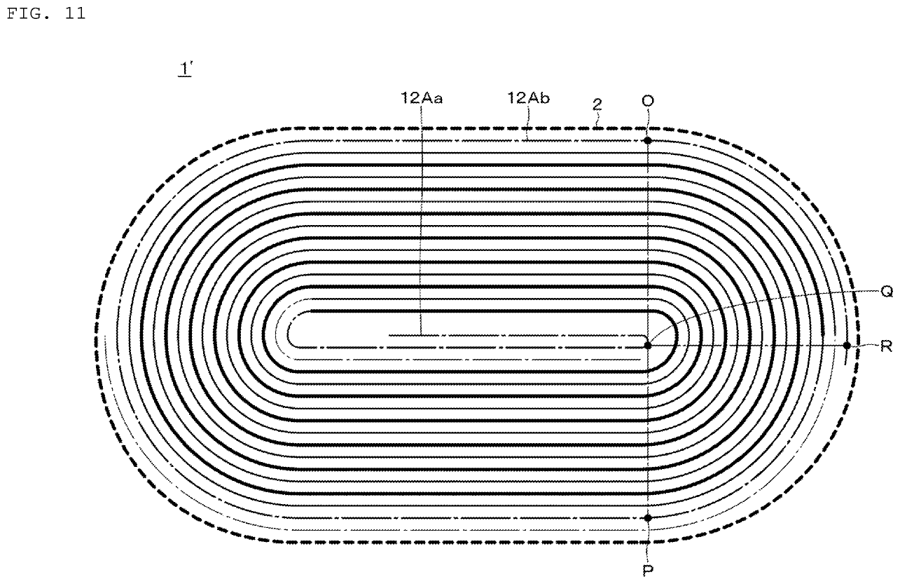

Furthermore, as shown in FIG. 11, the present technology can also be applied to a wound electrode body 1′ having an elliptical cross section. The wound electrode body 1′ having an elliptical cross section is also included in the concept of the wound electrode body 1 with a substantially cylindrical shape. FIG. 11 is a view in which a convex portion is omitted, and a broken line in FIG. 11 indicates the exterior material 2. For example, a convex portion is formed in the semicircular substantially central position (position of point R) of the both sides of the wound electrode body 1′. As to the projection amount of the convex portion of the wound electrode body 1′, for example, when using a curve obtained by circular approximation of the negative electrode current collector 12A as a reference, this curve is obtained as follows.

A perpendicular line is drawn at a turn-back position of an innermost negative electrode current collector 12Aa. Two points of intersection of this perpendicular line and an outermost peripheral negative electrode current collector 12Ab are defined as point O and point P, respectively. A middle point of side OP connecting the point O and the point P is defined as Q. A line perpendicular to the side OP passing through the point Q is drawn, and a point of intersection of this line and the outermost peripheral negative electrode current collector 12Ab is defined as R. An approximate curve can be obtained by substituting coordinates of the points O, P and R into circle equation (x−a)²+(y−b)²=r².

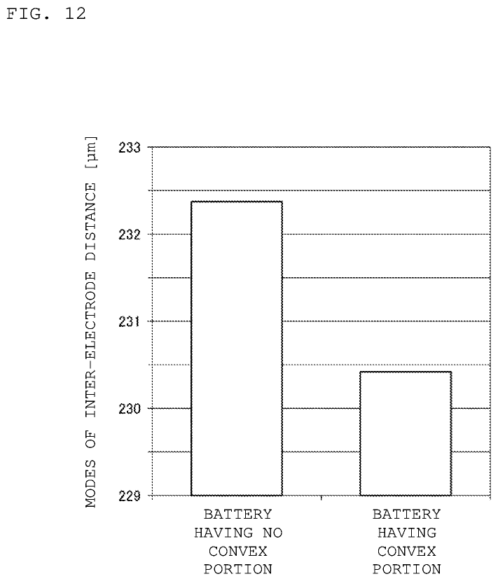

FIG. 12 is a graph showing modes of inter-electrode distance with respect to a battery having no convex portion projecting in an outer peripheral direction and a battery having a convex portion to which the present technology is applied. The inter-electrode distance referred herein refers to an inter-rotational distance of adjacent negative electrode current collectors. The mode refers to a class value at which a frequency is maximum in a frequency distribution table of the inter-electrode distance obtained at constant intervals (for example, 4 μm pitch) over the entire winding. The mode of inter-electrode distance in a shipping state of the battery having a convex portion in which the outermost peripheral current collector portion or the like of the wound electrode body according to the embodiment of the present technology projects in an outer peripheral direction is smaller than that of the battery having no convex portion. The small mode value indicates that the expansion of the wound electrode in the initial charge before shipment is suppressed. This reduces a diameter of the battery, and it is possible to provide a battery having a high volumetric energy density.

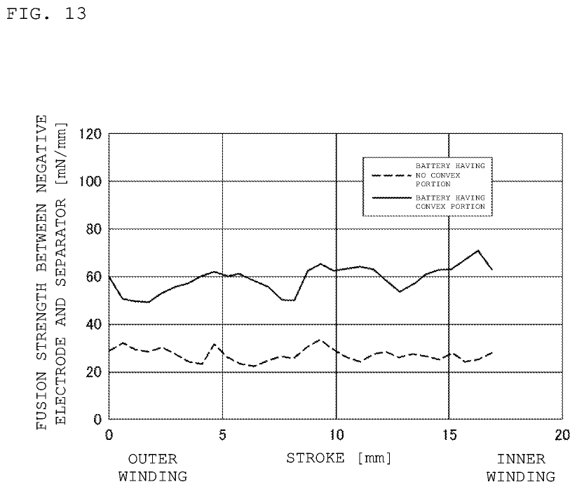

FIG. 13 is a graph showing fusion strength [mN/mm] of the negative electrode and the separator. Stroke [mm] on a horizontal axis is length of the separator peeled from the fixed negative electrode. A fusion strength between the negative electrode and the separator is higher in a fusion strength (solid line graph) of the battery in which the outermost peripheral current collector portion or the like of the wound electrode body according to the embodiment of the present technology has a convex shape in an outer peripheral direction than in a fusion strength (broken line graph) of the battery having no convex portion. The high fusion strength indicates that adhesion between the negative electrode 12 and the separator 13 of the wound electrode body 1 is high. Thus, the swelling during the cycle can be suppressed or cycle characteristics can be improved.

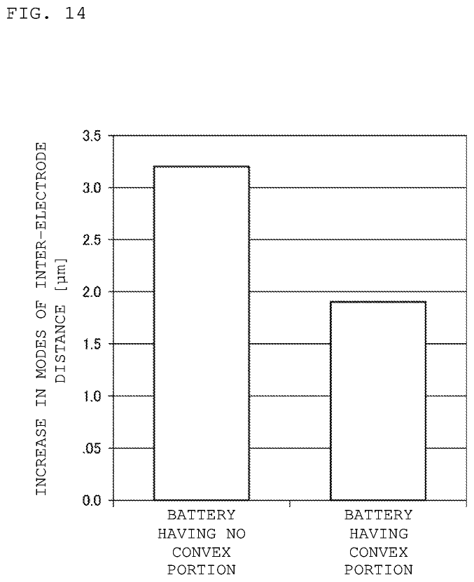

FIG. 14 represents increases in modes of inter-electrode distance from the shipping state to a next charging state after 100 cycles of charge and discharge. As in FIG. 12, the inter-electrode distance refers to a distance of one cycle from a copper foil to a copper foil, and the mode refers to a class value at which a frequency is maximum in a frequency distribution table of the inter-electrode distance obtained at constant intervals (for example, 4 μm pitch) over the entire winding. The increase in modes of the battery in which the outermost peripheral current collector portion or the like of the wound electrode body according to the embodiment of the present technology has a convex shape in an outer peripheral direction is smaller than that of the battery having no convex portion. This indicates that the swelling due to the cycle was suppressed.

As described above, since the convex portion in which the outermost peripheral current collector portion or the like of the wound electrode body projects in an outer peripheral direction is in the vicinity of the thermally fused portion (joint parts 23) of the exterior material 2, the wound electrode body 1 is fixed at the convex portion, whereby expansion of the wound electrode body 1 and loosening of the wound electrode body 1 can be suppressed, and the fusion strength between the negative electrode 12 and the separator 13 can be increased. Thus, a battery having a high volumetric energy density can be provided, and the swelling during the cycle can be suppressed or cycle characteristics can be improved.

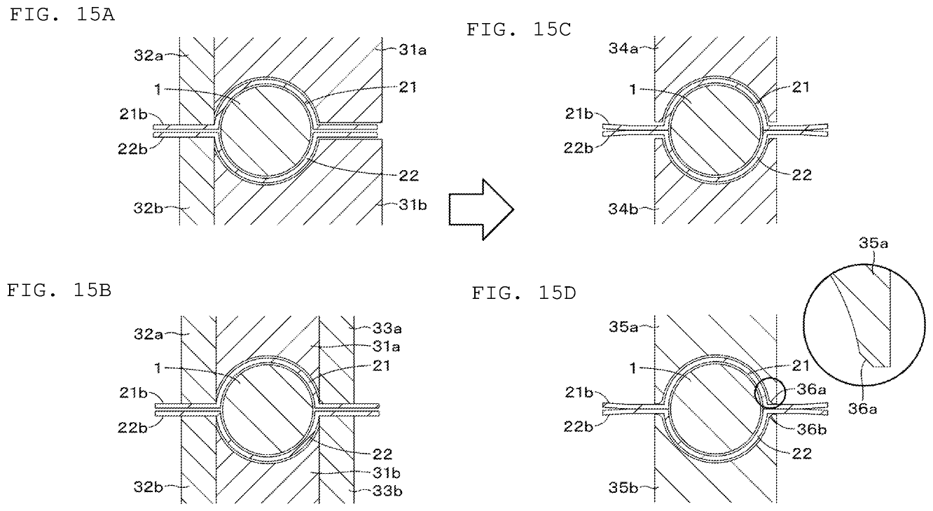

The convex portion described above can be adjusted in shape, for example, by shape, conditions and the like of a mold in pressure molding. FIG. 15 shows an example of a process such as pressure molding in the case of specification of electrode coated with gel electrolyte. As shown in FIG. 15A, the wound electrode body 1 is stored in the space part of the exterior materials 21 and 22. The peripheral edge part 21b of the exterior material 21 and the peripheral edge part 22b of the exterior material 22 are overlapped. The peripheral edge parts 21b and 22b are thermally fused by heat molds 32a and 32b while being supported by support molds 31a and 31b. In this case, as shown in FIG. 15B, both sides of the peripheral edge part may be thermally fused simultaneously using the heat molds 32a and 32b and heat molds 33a and 33b. Furthermore, four sides of the peripheral edge part may be thermally fused simultaneously.

Next, treatment with gel permeation, or gel crosslinking and gel permeation is performed. Conventionally, as shown in FIG. 15C, the wound electrode body 1 is heated while being appropriately pressurized by heat molds 34a and 34b, thereby bringing the positive electrode, the separator, and the negative electrode into close contact. The same process is performed in the present technology, but as shown in FIG. 15D, corners of end faces of heat molds 35a and 35b opposed each other across the thermally fused portion (at least one side of the peripheral edge parts 21b and 22b) are cut off at an angle or formed into an appropriate R-shape to form inclined surfaces 36a and 36b which allow slight deformation of the wound electrode body 1. That is, among the corners extending in the longitudinal direction of the wound electrode body 1, the corners closer to the boundaries between the peripheral edge parts 21a and 21b and the space parts 22a and 22b are cut off at an angle or formed into an appropriate R-shape.

When the end face of the heat mold 35a having the inclined surface or R surface 36a and the end face of the heat mold 35b having the inclined surface or R surface 36b oppose each other across the peripheral edge parts 21b and 22b, the concave portion (or groove) having a triangular cross section is formed by the inclined surface or R surface 36a and the inclined surface or R surface 36b. Since the heat molds 35a and 35b pressurize the wound electrode body 1, a part of the peripheral surface of the wound electrode body 1 enters the concave portion (or groove) to form a convex portion.

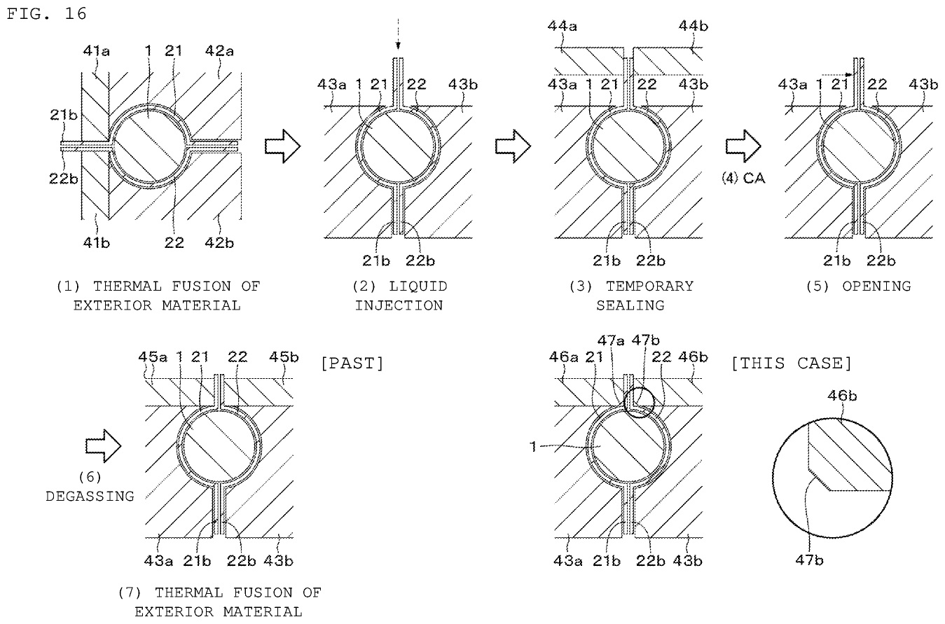

FIG. 16 shows an example of a process in the case of liquid injection type specification. First, three sides out of four sides of the peripheral edge part 21b of the exterior material 21 and the peripheral edge part 22b of the exterior material 22 are thermally fused by heat molds 41a and 41b. The exterior materials 21 and 22 in which the wound electrode body 1 is stored are supported by support molds 42a and 42b.

Next, the exterior materials 21 and 22 in which the wound electrode body 1 is stored are supported by support molds 43a and 43b, and the composition for electrolyte is injected from one side of the peripheral edge part which is not thermally fused into the inside of the exterior materials 21 and 22.

Next, a part of the tip side of the peripheral edge part used for injection is thermally fused by heat molds 44a and 44b (temporary sealing). After performing CA (activation charge (or activation charge/discharge) of the battery), the temporarily sealed peripheral edge part is cut, and the exterior materials 21 and 22 are opened.

Through degassing process of discharging the internal gas, the peripheral edge parts of the exterior materials 21 and 22 are thermally fused by heat molds 45a and 45b. Thus, a sealing process is performed. In the case of specification of crosslinked electrolyte, a heating process (crosslinking promoting process) is inserted between the third temporary sealing process and the fourth CA process.

Conventionally, the angle of corners of opposing end faces of the heat molds 45a and 45b has been 90 degrees. In the present technology, lower corners of the opposing end faces of heat molds 46a and 46b are cut off at an angle or formed into an appropriate R-shape to form inclined surfaces or R surfaces 47a and 47b, respectively. When the end face of the heat mold 46a and the end face of the heat mold 46b oppose each other across the peripheral edge parts 21b and 22b, the concave portion (or groove) having a triangular cross section is formed by the inclined surface or R surface 47a and the inclined surface or R surface 47b. When the heat molds 46a and 46b slightly pressurize the wound electrode body 1, a part of the peripheral surface of the wound electrode body 1 enters the concave portion (or groove) to form a convex portion

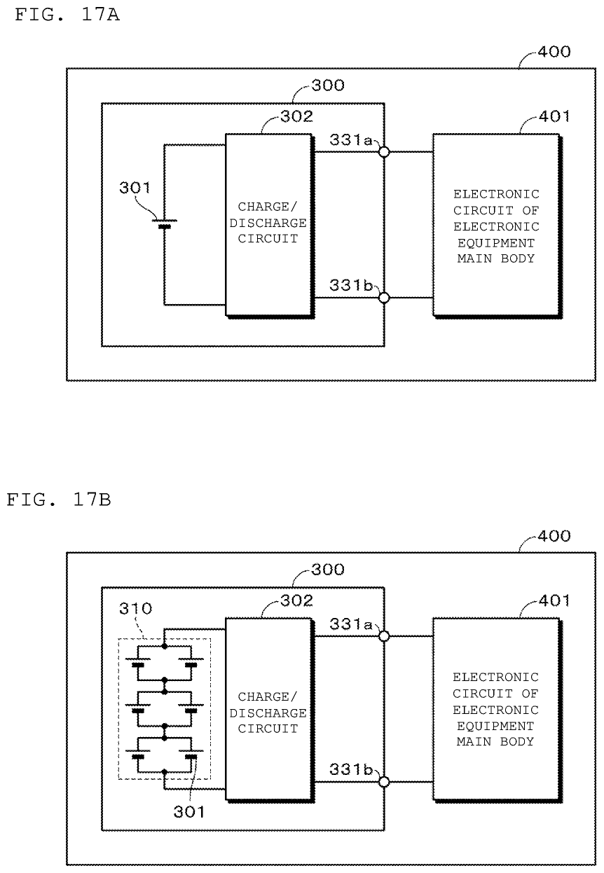

FIG. 17A is a block diagram showing an example of a configuration of electronic apparatus according to a second embodiment of the present technology. Electronic apparatus 400 includes an electronic circuit 401 of the electronic apparatus main body and a battery pack 300. The battery pack 300 is electrically connected to the electronic circuit 401. The electronic apparatus 400 has, for example, a configuration in which the battery pack 300 can be freely attached and detached by a user. The configuration of the electronic apparatus 400 is not limited thereto, and the electronic apparatus 400 may have a configuration in which the battery pack 300 is incorporated in the electronic apparatus 400 so that the battery pack 300 cannot be removed from the electronic apparatus 400 by the user.

At the time of charging the battery pack 300, a positive electrode terminal 331a and a negative electrode terminal 331b of the battery pack 300 are connected to a positive electrode terminal and a negative electrode terminal of a charger (not shown), respectively. On the other hand, at the time of discharging the battery pack 300 (when using the electronic apparatus 400), the positive electrode terminal 331a and the negative electrode terminal 331b of the battery pack 300 are connected to a positive electrode terminal and a negative electrode terminal of the electronic circuit 401, respectively.

The electronic apparatus 400 is, for example, a portable electronic apparatus. The electronic apparatus 400 may be a wearable electronic apparatus.

The electronic circuit 401 includes, for example, a CPU, a peripheral logic unit, an interface unit, a storage unit, and the like, and controls the overall electronic apparatus 400.

The battery pack 300 includes a secondary battery 301 and a charge/discharge circuit 302. As the secondary battery 301, the battery according to the above-described first embodiment can be used.

At the time of charge, the charge/discharge circuit 302 controls charging to the secondary battery 301. On the other hand, at the time of discharge (that is, when using the electronic apparatus 400), the charge/discharge circuit 302 controls discharging to the electronic device 400.

FIG. 17B is a block diagram showing an example of a configuration of electronic apparatus according to a modified example of the second embodiment of the present technology. In the second embodiment, an assembled battery 310 may be used. The assembled battery 310 is configured to have a plurality of secondary batteries 301 electrically connected in at least one of parallel and series. The plurality of secondary batteries 301 are connected so as to arrange, for example, n batteries in parallel and m batteries in serial (n and m are positive integers). For electrical connection of the plurality of secondary batteries 301, for example, the positive and negative electrode leads 3a and 4a are used (see, for example, FIG. 1A). It is to be noted that FIG. 17B shows therein an example where six secondary batteries 301 are connected so as to arrange two batteries in parallel and three batteries in series (2P3S).

While the embodiments of the present technology have been concretely described above, the present technology is not to be considered limited to one embodiment described above, and it is possible to make various modifications based on technical idea of the present technology. Moreover, the configurations, methods, processes, shapes, materials, numerical values, and the like cited in the above-described embodiments are considered by way of example only, and configurations, methods, steps, shapes, materials, and numerical values may be used which are different from the foregoing, if necessary. For example, the exterior material 2 is not limited to a configuration in which the two exterior materials are separated, and may be configured to be foldably connected at one of the peripheral edge parts. In addition, a sealed part provided at the end face side of the housing part may be shifted from a central position of the end face.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery comprising:
a wound electrode body with a substantially cylindrical shape, wherein the wound electrode body includes a positive electrode, a negative electrode, and a separator, and
an exterior material configured to cover the wound electrode body, wherein
in at least one round from an outermost periphery of winding of the wound electrode body, one or more of a positive electrode, a negative electrode, a positive electrode current collector and a negative electrode current collector include at least one convex portion projecting in an outer peripheral direction.

2. The battery according to claim 1, wherein a height of the convex portion of the positive electrode, the negative electrode, the positive electrode current collector and the negative electrode current collector is from 10 μm to 1 mm, and wherein the height is measured by using a curve obtained by circular approximation of the positive electrode, the negative electrode, the positive electrode current collector or the negative electrode current collector as a reference line.

3. The battery according to claim 1, wherein, in at least one round from the outermost periphery of winding of the wound electrode body, a curve obtained by circular approximation of the exterior material crosses at least one of the positive electrode, the negative electrode, the positive electrode current collector and the negative electrode current collector.

4. The battery according to claim 1, wherein the exterior material includes a housing part with a substantially cylindrical shape for housing the wound electrode body and peripheral edge parts provided on four sides around the housing part are sealed.

5. The battery according to claim 1, wherein the exterior material includes a housing part with a substantially cylindrical shape for housing the wound electrode body, and peripheral edge parts provided on three sides around the housing part, excluding a bent portion on a peripheral surface side, are sealed at the peripheral edge parts.

6. The battery according to claim 5, wherein a peripheral edge part provided on an end face side of the housing part is shifted from a central position of the end face side.

7. The battery according to claim 1, wherein at least a part of the convex portion is fitted into a concave portion provided on an inner surface of a joint part.

8. An assembled battery comprising a plurality of the batteries according to claim 1.

9. An electronic apparatus comprising the battery according to claim 1.

10. A method for manufacturing a battery, comprising:
forming a first film-like exterior material having a first housing part with a substantially partially cylindrical shape and a second film-like exterior material having a second housing part with a substantially partially cylindrical shape;
housing a wound electrode body in the first housing part and the second housing part;
when heat-molding the wound electrode body by thermal fusion, using a mold without rectangular corners or a mold in which an appropriate R-shape is formed at the corners; and
forming at least one or more convex portions projecting in an outer peripheral direction on an outer peripheral surface of the wound electrode body.

11. The method for manufacturing the battery according to claim 10, wherein a concave portion is formed on an inner surface of a joint surface of thermal fusion, and wherein at least a part of the convex portion is fitted into the concave portion.
